(19) United States
(12) Patent Application Publication
(10) Pub. No.: US 2010/0207583 A1
(43) Pub. Date: Aug. 19, 2010

(54) CHARGING METHOD AND CHARGING/DISCHARGING METHOD OF LITHIUM ION SECONDARY BATTERY

(76) Inventors: Ryoichi Tanaka, Osaka (JP); Yasuhiko Hina, Hyogo (JP); Akira Nagasaki, Osaka (JP)

Correspondence Address: MCDERMOTT WILL & EMERY LLP, 600 13TH STREET, NW, WASHINGTON, DC, 20005-3096, US

(21) Appl. No.: 12/680,095

(22) PCT Filed: Mar. 26, 2009
(86) PCT No.: PCT/JP2009/001372

§ 371 Date: Mar. 25, 2010

(30) Foreign Application Priority Data
Jun. 12, 2008 (JP) 2008-154311

(51) Int. Cl. H02J 7/00; H02J 7/04

(52) U.S. Cl. 320/134; 320/162

(57) ABSTRACT

The present invention relates to a charging method of a lithium ion secondary battery including, as a positive electrode active material, a lithium-containing composite oxide containing nickel and cobalt and having a layered crystal structure. The charging method includes a first step of charging the battery at a first current of 0.5 to 0.7 It until the charge voltage of the battery reaches a first upper limit voltage of 3.8 to 4.0 V; a second step of charging the battery, upon completion of the first step, at a second current smaller than the first current until the charge voltage of the battery reaches a second upper limit voltage greater than the first upper limit voltage; and a third step of charging the battery, upon completion of the second step, at the second upper limit voltage. This provides a charging method of a lithium ion secondary battery, the method capable of achieving both a shortened charging time and an improvement in charge/discharge cycle life characteristics.

### TECHNICAL FIELD

The present invention relates to a charging method and a charging/discharging method of a lithium ion secondary battery including a specific positive electrode active material.

### BACKGROUND ART

Conventionally, lithium ion secondary batteries having a high voltage and a high energy density have been widely used as power sources of electronic devices such as notebook computers, cellular phones, and AV devices. In such lithium ion secondary batteries, for example, a carbon material capable of absorbing and desorbing lithium is used as a negative electrode active material, and a composite oxide of lithium and cobalt (LiCoO₂) having a layered crystal structure is used as a positive electrode active material.

In recent years, as electronic devices become smaller in size and higher in performance, there has been an increasing demand for achieving a higher capacity and a longer service life of lithium ion secondary batteries. Further, as the frequency of the use of electronic devices has been increased with the advancement of ubiquitous network society, there has been a strong demand for shortening the charging time of the batteries.

With regard to the achievement of a higher capacity, possible solutions include, for example, increasing the packing density of LiCoO₂ having a high energy density, and raising the upper limit of the charge voltage to be greater than the conventional upper limit of 4.2 V to increase the utilizing ratio of the active material itself.

However, increasing the packing density of the active material may result in a degradation of the charge/discharge cycle life characteristics; and raising the upper limit of the charge voltage to be greater than the conventional upper limit of 4.2 V may result in a degradation of the reliability, particularly, the safety and the charge/discharge cycle life characteristics in a high temperature environment.

As a method of improving the charge/discharge cycle life characteristics, there has been proposed a method of decreasing the charge current and thereby suppressing the degradation of the cycle life characteristics resulted from a reduction in the acceptability of Li at the negative electrode that occurs in the course of achieving a higher capacity. There has been proposed another method of lowering the upper limit of the charge voltage to be smaller than the conventional upper limit of 4.2 V and thereby suppressing the degradation of the cycle life characteristics that occurs as the decomposition reaction of the electrolyte proceeds. In these methods, however, the charging time becomes longer, and therefore, it is very difficult to achieve both a shortened charging time and an improvement in cycle life characteristics.

In addition to the above, for example, according to a method proposed in Patent Document 1, in a method of charging using a set of constant current pulses that decrease stepwise, the charge current be decreased every time when the voltage reaches a predetermined cut-off voltage.

Patent Document 1: Japanese Laid-Open Patent Publication No. Hei 10-145979

### DISCLOSURE OF THE INVENTION

### Problem to be Solved by the Invention

However, in Patent Document 1, an internal resistance is calculated on the basis of the change in voltage upon the cutting off of the current, and a value obtained by multiplying the calculated internal resistance by a predetermined charge current is added to the cut-off voltage, thereby to determine a cut-off voltage of the subsequent pulse charging. As such, if the change in voltage upon the cutting off of the current (i.e., the internal resistance) is large, the cut-off voltage becomes high, falling in an overcharged state. As a result, the cycle life characteristics may be degraded.

As another example, in a lithium ion secondary battery including a lithium-containing composite oxide containing nickel and cobalt (hereinafter referred to as a “nickel-containing active material”) having a potential lower than a lithium cobaltate as a positive electrode active material, compared to a lithium ion secondary battery including a lithium cobaltate as a positive electrode active material, the charging time can be shortened in a normal constant-current/constant-voltage charging. When a battery including a nickel-containing active material and a battery including a lithium cobaltate are subjected to a constant-current/constant-voltage charging with the upper limit voltages set at the same voltage, the constant-current charging time of the battery including a nickel-containing active material is longer than that of the battery including a lithium cobaltate, and the ratio of the constant-current charging time to the overall charging time is larger. As the constant-current charging time becomes longer, a larger amount of electricity can be charged for a shorter period of time.

As described above, the battery including a nickel-containing active material can shorten the charging time as compared to the battery including a lithium cobaltate. In the battery including a nickel-containing active material, when charged for the same length of time as the battery including a lithium cobaltate, the charge current can be decreased. As such, in the battery including a nickel-containing active material, the charge/discharge cycle life characteristics can be improved by decreasing the charge current, while almost the same length of charging time as that in the battery including a lithium cobaltate can be ensured. However, the effect of shortening the charging time obtained by using the nickel-containing active material cannot be obtained sufficiently.

In view of the above, in order to solve the above-discussed conventional problems, the present invention intends to provide a charging method and a charging/discharging method of a lithium ion secondary battery in which the ratio of the constant-current charging time in a constant-current/constant-voltage charging is increased, the methods being capable of achieving both a shortened charging time and an improvement in cycle life characteristics.

### Means for Solving the Problem

The present invention relates to a charging method of a lithium ion secondary battery including, as a positive electrode active material, a lithium-containing composite oxide containing nickel and cobalt and having a layered crystal structure, the method comprising:

a first step of charging the battery at a first current of 0.5 to 0.7 It until the charge voltage of the battery reaches a first upper limit voltage of 3.8 to 4.0 V;

a second step of charging the battery, upon completion of the first step, at a second current smaller than the first current until the charge voltage of the battery reaches a second upper limit voltage greater than the first upper limit voltage; and

a third step of charging the battery, upon completion of the second step, at the second upper limit voltage.

Preferably, the lithium-containing composite oxide is represented by the general formula: LiNiₓCo_{y}M_{(1-x-y)}O₂, where M is at least one element selected from the group consisting of Group 2 elements, Group 3 elements, Group 4 elements, and Group 13 elements in the long form of the periodic table, and x and y satisfy 0.3≦x<1.0 and 0<y<0.4.

The second upper limit voltage is preferably 4.0 to 4.2 V.

The second current is preferably 0.3 to 0.5 It.

The present invention relates to a charging/discharging method of a lithium ion secondary battery including the step of repeating a cycle of charging the battery according to the above-described charging method and subsequent discharging, wherein the first current is decreased at a predetermined rate every cycle.

The present invention relates to a charging/discharging method of a lithium ion secondary battery including the step of repeating a cycle of charging the battery according to the above-described charging method and subsequent discharging, wherein the first current is decreased by a predetermined value at intervals of a predetermined number of cycles.

### EFFECT OF THE INVENTION

According to the present invention, it is possible to provide a charging method and a charging/discharging method of a lithium ion secondary battery, the methods being capable of achieving both a shortened charging time and an improvement in cycle life characteristics.

### BRIEF DESCRIPTION OF THE DRAWING

FIG. 1 is a schematic longitudinal sectional view of a lithium ion secondary battery used in Examples of the present invention.

### BEST MODE FOR CARRYING OUT THE INVENTION

The present invention relates to a charging method of a lithium ion secondary battery including, as a positive electrode active material, a lithium-containing composite oxide containing nickel and cobalt and having a layered crystal structure. The present invention is characterized by charging the above-described lithium ion secondary battery by a method comprising the following three steps.

First step: A first constant-current charging step of charging the battery at a first current (high rate) of 0.5 to 0.7 It until the charge voltage of the battery reaches a first upper limit voltage of 3.8 to 4.0 V.

Second step: A second constant-current charging step of charging the battery, upon completion of the first step, at a second current (low rate) smaller than the first current until the charge voltage of the battery reaches a second upper limit voltage greater than the first upper limit voltage.

Third step: A constant-voltage charging step of charging the battery, upon completion of the second step, at the foregoing second upper limit voltage.

Here, the “It” as used above represents the current and is defined as It (A)/X (h)=Rated capacity (Ah)/X (h), where X is a length of time expressed in hours during which an amount of electricity equivalent to the rated capacity is charged or discharged. For example, 0.5 It means that the current value is equal to Rated capacity (Ah)/2 (h).

In the battery including a lithium-containing composite oxide containing nickel and cobalt and having a potential lower than LiCoO₂, as a positive electrode active material, compared to a battery including LiCoO₂ as a positive electrode active material, the charge voltage profile is low, and it takes a longer time for the charge voltage at the time of constant current charging to reach an upper limit voltage of 3.8 to 4.0 V.

This feature is utilized in the present invention, and the constant current charging is performed in two steps of a high-rate charging step of charging the battery at a constant current exceeding a recommended current until the charge voltage of the battery reaches 3.8 to 4.0 V, and a low-rate charging step of charging the battery, after the charge voltage of the battery reached 3.8 to 4.0 V, at a constant current smaller than the recommended current until the charge voltage of the battery reaches a predetermined upper limit voltage. By doing this, the constant-current charging time becomes sufficiently long (the ratio of the constant-current charging time to the overall charging time becomes larger), the overall charging time can be shortened, and the time required for full charge can be shortened.

By employing the above-described charging method in charge/discharge cycles, it is possible to obtain excellent cycle life characteristics and to achieve both a shortened charging time and an improvement in cycle life characteristics.

When the first upper limit voltage exceeds 4.0 V, the charge (lithium ion) acceptability at the negative electrode is reduced, causing the cycle life to be degraded. When the first upper limit voltage is smaller than 3.8 V, the charging time is prolonged. In order to obtain more excellent cycle life characteristics, the first upper limit voltage is preferably 3.8 to 3.9 V.

The first current is preferably 0.5 to 0.7 It. When the first current is smaller than 0.5 It, the charging time is prolonged. When the first current exceeds 0.7 It, the charge acceptability at the negative electrode tends to be reduced, and thus the cycle life characteristics are likely to be degraded.

The second upper limit voltage is preferably 4.0 to 4.2 V. When the second upper limit voltage exceeds 4.2 V, due to the occurrence of side reactions such as the decomposition reaction of electrolyte, the cycle life characteristics are likely to be degraded.

The second current is preferably 0.3 to 0.5 It. When the depth of charge is high, the charge acceptability at the negative electrode tends to be reduced.

The cut-off current in the third step is, for example, 50 to 140 mA.

The charging/discharging method of the present invention relates to a method of correcting the first current in repeating a cycle of charging under the above-described conditions and subsequent discharging, wherein the correction is made depending on the deterioration of the battery (electrode) associated with charge/discharge cycles.

Specifically, an exemplary method is a method of correcting the first current every cycle on the basis of the deterioration ratio of the battery (electrode), that is, a method of decreasing the first current at a predetermined rate depending on the deterioration of the battery (electrode). For example, assuming that the first current at the (n−1)th cycle is P and the deterioration ratio of the battery (electrode) (e.g., the ratio of the capacity decreased) is Q (%), the first current at the (n) th cycle is equal to P×(1−Q/100).

Another exemplary method is a method of decreasing the first current by a predetermined value at intervals of a predetermined number of cycles. The value to be decreased at intervals of a predetermined number of cycles may be set appropriately, for example, on the basis of the data obtained in advance regarding the cycle life characteristics of the battery.

By employing the methods as described above, it is possible to suppress the deterioration of the electrode resulted from an increase in polarization associated with charge/discharge cycles, and to prevent the charging time in the first step from becoming shorter and thus prevent the ratio of the charging time in the first step to the overall charging time from being reduced.

As the discharging method, for example, a method of discharging at a discharge current of 0.2 to 1.0 It until the voltage reaches a cut-off voltage of 2.5 V may be employed.

In the following, the lithium ion secondary battery used for the above-described charging method and charging/discharging method is described.

The positive electrode comprises, for example, a positive electrode current collector, and a positive electrode active material layer formed on the positive electrode current collector. The positive electrode active material layer comprises, for example, a mixture of a positive electrode active material, a conductive material, and a binder.

As the positive electrode active material, a lithium-containing composite oxide represented by the general formula: LiNiₓCo_{y}M_{(1-x-y)}O₂, where M is at least one element selected from the group consisting of Group 2 elements, Group 3 elements, Group 4 elements, and Group 13 elements in the long form of the periodic table, and x and y satisfy 0.3≦x<1.0 and 0<y<0.4. By using this lithium-containing composite oxide, the effect of shortening the charging time and improving the cycle life characteristics can be remarkably exerted. The lithium-containing composite oxide may be prepared by a known method.

When x is less than 0.3, the effect of decreasing the charge voltage is reduced. When y is 0.4 or more, the effect of decreasing the charge voltage is reduced. Adding M makes it possible to achieve an improvement in cycle life characteristics and a higher capacity. Examples of Group 2 elements include Mg and Ca; examples of Group 3 elements include Sc and Y; examples of Group 4 elements include Ti and Zr; and examples of Group 13 elements include B and Al. Among these, M is preferably Al because it provides a highly stable crystal structure and an ensured safety.

As the conductive material, for example, a carbon material such as natural graphite, artificial graphite, carbon black or acetylene black is used. As the binder, for example, polyvinylidene fluoride or polytetrafluoroethylene is used. For the positive electrode current collector, a metallic foil such as an aluminum foil is used. The positive electrode is obtained by, for example, applying a positive electrode paste prepared by dispersing a mixture of the positive electrode active material, the conductive material, and the binder in a dispersion medium of N-methyl-2-pyrrolidone or the like, onto the positive electrode current collector, and then drying the paste.

The negative electrode comprises, for example, a negative electrode current collector, and a negative electrode active material layer formed on the negative electrode current collector. The negative electrode active material layer comprises, for example, a mixture of a negative electrode active material, a conductive material, and a binder. For the negative electrode active material, a carbon material capable of absorbing and desorbing lithium, such as artificial graphite or natural graphite, is used. For the negative electrode current collector, a metallic foil such as a nickel foil or copper foil is used. For the conductive material and the binder, the same material as used in the positive electrode may be used. The negative electrode is obtained by, for example, applying a negative electrode paste prepared by dispersing a mixture of the negative electrode active material, the conductive material, and the binder in a dispersion medium of N-methyl-2-pyrrolidone or the like, onto the negative electrode current collector, and then drying the paste.

The electrolyte comprises, for example, a non-aqueous solvent, and a supporting salt dissolving in the non-aqueous solvent. As the supporting salt, for example, a lithium salt such as lithium hexafluorophosphate is used. As the non-aqueous solvent, for example, a mixed solvent of a cyclic ester such as ethylene carbonate and propylene carbonate, and a chain ester such as dimethyl carbonate, diethyl carbonate, and methyl ethyl carbonate is used.

It should be noted that according to the present invention, even when a battery pack including a plurality of the above-described lithium ion batteries is used, by charging or charging/discharging in the same manner as described above, both a shortened charging time and an improvement in charge/discharge cycle life characteristics of the battery pack can be achieved. In the case of a battery pack, in correcting the first current depending on the charge/discharge cycles in the above charging/discharging method, for example, the cycle count function of a battery management unit (BMU) incorporated in the battery pack may be utilized

### EXAMPLES

Examples of the present invention are described in below in detail, but it should be noted that the present invention is not limited to these examples.

### Examples 1 to 6

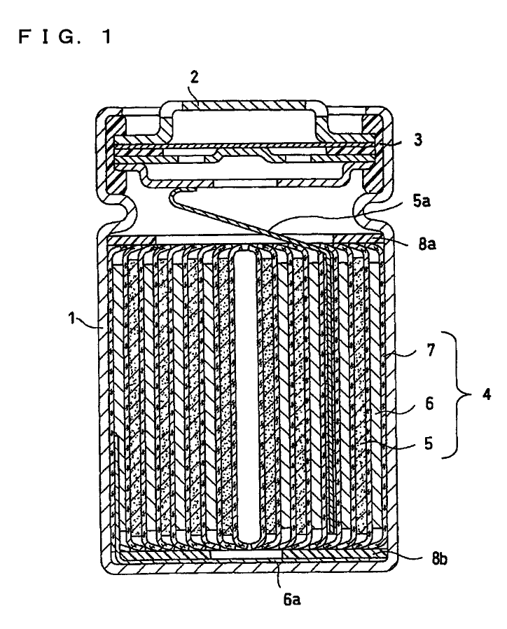

A cylindrical lithium ion secondary battery as shown in FIG. 1 used in the charging method of the present invention was fabricated in the following procedures.

### (1) Production of Positive Electrode

First, 100 parts by weight of LiNi_{0.8}Co_{0.15}Al_{0.05}O₂ serving as the positive electrode active material, 1.7 parts by weight of polyvinylidene fluoride serving as the binder, 2.5 parts by weight of acetylene black serving as the conductive material, and an appropriate amount of N-methyl-2-pyrrolidone were stirred in a double arm kneader, to give a positive electrode paste. Here, the positive electrode active material was prepared in the following manner. To an aqueous NiSO₄ solution, sulfates of Co and Al in a predetermined ratio were added to prepare a saturated aqueous solution. While the resultant saturated aqueous solution was being stirred, an aqueous sodium hydroxide solution was slowly added dropwise to the saturated aqueous solution to neutralize it, whereby a precipitate of hydroxide Ni_{0.8}C_{0.15}Al_{0.05}(OH)₂ was obtained by a coprecipitation method. The obtained precipitate was collected by filtration, washed with water, and then dried at 80° C. To the hydroxide thus obtained, a lithium hydroxide monohydrate was added in an amount such that the sum of the number of moles of Ni, Co and Al became equal to the number of moles of Li, and then heated at 800° C. in dry air for 10 hours. In such a manner, LiNi_{0.8}Co_{0.15}Al_{0.05}O₂ was obtained.

The positive electrode paste was applied onto both surfaces of the positive electrode current collector made of a 15-μm-thick aluminum foil, and dried, to form a positive electrode active material layer on both surfaces of the positive electrode current collector, whereby a plate-like positive electrode was obtained. Thereafter, the resultant positive electrode was rolled and cut, to obtain a band-like positive electrode 5 (thickness: 0.128 mm, width: 57 mm, and length: 667 mm).

### (2) Production of Negative Electrode

First, 100 parts by weight of graphite serving as the negative electrode active material, 0.6 parts by weight of polyvinylidene fluoride serving as the binder, 1 part by weight of carboxymethylcellulose serving as the thickener, and an appropriate amount of water were stirred in a double arm kneader, to give a negative electrode paste. The negative electrode paste thus obtained was applied onto both surfaces of the negative electrode current collector made of an 8-μm-thick copper foil, and dried, to form a negative electrode active material layer on both surfaces of the negative electrode current collector, whereby a plate-like negative electrode was obtained. Thereafter, the resultant negative electrode was rolled and cut, to obtain a band-like negative electrode 6 (thickness: 0.155 mm, width: 58.5 mm, and length: 745 mm).

### (3) Preparation of Non-Aqueous Electrolyte

In a non-aqueous solvent obtained by mixing ethylene carbonate, methyl ethyl carbonate, and dimethyl carbonate in a volume ratio of 1:1:8, LiPF₆ was dissolved at a concentration of 1 mol/L, to prepare a non-aqueous electrolyte.

### (4) Fabrication of Battery

The positive electrode 5 and the negative electrode 6 obtained in the above, and a separator 7 for separating both electrodes from each other were wound in a coil, to form an electrode assembly 4. For the separator 7, a 16-μm-thick microporous film made of polypropylene was used. The electrode assembly 4 thus formed was inserted into a bottomed-cylindrical battery case 1 (diameter: 18 mm, and height: 65 mm). On the upper and lower portions of the battery assembly 4, insulating rings 8a and 8b were placed, respectively. The non-aqueous electrolyte prepared in the above was injected into the battery case 1. A negative electrode lead 6a drawn from the negative electrode 6 was welded onto the inner bottom surface of the battery case 1; and a positive electrode lead 5a drawn from the positive electrode 5 was welded onto the lower surface of the a battery lid 2. The opening end of the battery case 1 was crimped onto the periphery of the battery lid 2 with a gasket 3 interposed therebetween, to seal the opening of the battery case 1. In such a manner, a 18650-size cylindrical lithium ion secondary battery (diameter: 18 mm, and height: 65 mm) was fabricated.

### (5) Charge/Discharge Cycle Life Test

The batteries fabricated in the above were used to conduct a charge/discharge cycle life test in the following manner.

The batteries fabricated in the above were charged at a first current of 0.5 It or 0.7 It until the charge voltage reached a first upper limit voltage of 3.8 V, 3.9 V or 4.0 V (the first step: a high-rate CC charging). Upon completion of the first step, the foregoing batteries were charged at a second current of 0.3 It, which was smaller than the first current, until the charge voltage reached a second upper limit voltage of 4.2 V (the second step: a low-rate CC charging). Upon completion of the second step, the foregoing batteries were charged at the second upper limit voltage of 4.2 V until the charge current was decreased to 50 mA (the third step: a CV charging).

The batteries charged in such a manner were allowed to stand for 20 minutes. Thereafter, the foregoing batteries were discharged at 1.0 It. The end-of-discharge voltage was set at 2.5 V.

The above charge/discharge cycle was repeated for a total of 300 cycles. The conditions for the charging in Examples 1 to 6 are shown in Table 1.

TABLE 1

| | First step | | Second step | | | |
|---|---|---|---|---|---|---|
| | (High-rate CC | | (Low-rate CC | | Third step | |
| | charging) | | charging) | | (CV charging) | |
| | | 1st upper | | 2nd upper | | End-of- |
| | 1st | limit | 2nd | limit | Charge | charge |
| | current | voltage | current | voltage | voltage | current |
| | (A) | (V) | (A) | (V) | (V) | (mA) |
| Example 1 | 0.5 It | 3.8 | 0.3 It | 4.2 | 4.2 | 50 |
| Example 2 | 0.5 It | 3.9 | 0.3 It | 4.2 | 4.2 | 50 |
| Example 3 | 0.5 It | 4.0 | 0.3 It | 4.2 | 4.2 | 50 |
| Example 4 | 0.7 It | 3.8 | 0.3 It | 4.2 | 4.2 | 50 |
| Example 5 | 0.7 It | 3.9 | 0.3 It | 4.2 | 4.2 | 50 |
| Example 6 | 0.7 It | 4.0 | 0.3 It | 4.2 | 4.2 | 50 |

### Comparative Examples 1 to 3

The cycle life test was conducted by employing a conventional constant-current/constant-voltage charging method of a lithium ion secondary battery. Specifically, the batteries fabricated in the above were subjected to a constant current charging at 0.3 It, 0.5 It or 0.7 It until the charge voltage reached an upper limit voltage of 4.2 V, and subsequently subjected to a constant voltage charging at 4.2 V until the charge current was decreased to 50 mA. Upon completion of the above charging, the batteries were allowed to stand for 20 minutes. Thereafter, the foregoing batteries were discharged at 1.0 It. The end-of-discharge voltage was set at 2.5 V. The above charge/discharge cycle was repeated for a total of 300 cycles. The conditions for the charging in Comparative Examples 1 to 3 are shown in Table 2.

TABLE 2

| | Constant current | | Constant voltage | |
|---|---|---|---|---|
| | charging | | charging | |
| | | Upper limit | Charge | End-of-charge |
| | Current | voltage | voltage | current |
| | (A) | (V) | (V) | (mA) |
| Comparative | 0.3 It | 4.2 | 4.2 | 50 |
| Example 1 | | | | |
| Comparative | 0.5 It | 4.2 | 4.2 | 50 |
| Example 2 | | | | |
| Comparative | 0.7 It | 4.2 | 4.2 | 50 |
| Example 3 | | | | |

### Comparative Examples 4 to 6

Lithium ion secondary batteries were fabricated in the same manner as described above except that LiCoO₂ was used as the positive electrode active material. With respect to the batteries thus fabricated, the cycle life test was conducted under the same conditions as in Comparative Examples 1 to 3 except that the end-of-discharge voltage was set at 3.0. V. The conditions for the charging in Comparative Examples 4 to 6 are shown in Table 3.

TABLE 3

| | Constant current | | Constant voltage | |
|---|---|---|---|---|
| | charging | | charging | |
| | | Upper limit | Charge | End-of-charge |
| | Current | voltage | voltage | current |
| | (A) | (V) | (V) | (mA) |
| Comparative | 0.3 It | 4.2 | 4.2 | 50 |
| Example 4 | | | | |
| Comparative | 0.5 It | 4.2 | 4.2 | 50 |
| Example 5 | | | | |
| Comparative | 0.7 It | 4.2 | 4.2 | 50 |
| Example 6 | | | | |

### [Evaluation]

The charge/discharge cycle was repeated for a total of 300 cycles as described above to check a discharge capacity at the 300th cycle, and a capacity retention rate was determined from the following equation:

Capacity retention rate (%)=Discharge capacity at 300th cycle/Discharge capacity at 1st cycle×100.

The results are shown in Table 4 together with the initial charging time (the charging time at the 1st cycle).

TABLE 4

| | Initial | Capacity |
|---|---|---|
| | charging time | retention rate |
| | (min) | (%) |
| Comparative Example 1 | 248 | 80 |
| Comparative Example 2 | 173 | 67 |
| Comparative Example 3 | 139 | 50 |
| Comparative Example 4 | 280 | 75 |
| Comparative Example 5 | 208 | 74 |
| Comparative Example 6 | 176 | 73 |
| Example 1 | 208 | 78 |
| Example 2 | 198 | 78 |
| Example 3 | 191 | 74 |
| Example 4 | 193 | 76 |
| Example 5 | 183 | 74 |
| Example 6 | 173 | 73 |

With regard to the battery of Comparative Example 2 charged at a constant current of 0.5 It, the charging time was almost the same as that of the battery of Comparative Example 6 including LiCoO₂ and having been charged at a constant current of 0.7 It, whereas the cycle life characteristic was slightly degraded as compared to that of the battery of Comparative Example 6. With regard to the battery of Comparative Example 1 charged at a constant current of 0.3 It, the cycle life characteristic was remarkably improved, whereas the charging time was considerably prolonged, compared to those of the battery of Comparative Example 6 including LiCoO₂ and having been charged at a constant current of 0.7 It.

From the results of Comparative Examples 1 to 3, it is understand that a larger charge current in the constant current charging can shorten the charging time, but causes the cycle life characteristic to be significantly degraded.

With regard to the battery of Example 1 in which the constant current step was performed in two steps consisting of high-rate charging and low-rate charging, the capacity retention rate was almost the same as that of the battery of Comparative Example 1. The charging time in Example 1 was shortened by about 40 minutes (about 16%) as compared to that in Comparative Example 1. In Examples 2 to 6 also, the charging times were shortened and the capacity retention rates were as high as 70% or more.

On the other hand, in Comparative Examples 2 and 3 in which the charging times were shortened by the conventional method, the capacity retention rates were significantly reduced.

These results indicate that the examples of the present invention employing the constant current step in which a high-rate charging is performed when the depth of charge is small, and thereafter a low-rate charging is performed with a decreased charge current, it is possible to achieve both a shortened charging time and an improvement in cycle life characteristics.

From the test results of Examples 1 to 6, it is understood that the first upper limit voltages of 3.8 V and 3.9 V provide more excellent cycle life characteristics as compared to the first upper limit voltage of 4.0 V. Accordingly, the first upper limit voltage is preferably 3.8 V or more and 3.9 V or less.

### Example 7

Next, with respect to a battery pack including a plurality of the lithium ion batteries of Example 1, the charge/discharge cycle life test was conducted to check the relationship between a charging time and a cycle life characteristic.

A battery pack including a battery assembly and a BMU was produced, the battery assembly including six batteries fabricated in the above connected two in parallel by three in series. The battery pack thus produced was used to conduct a cycle life test in the following manner.

The battery pack fabricated in the above was subjected to a constant current charging at a first current of 0.7 It until the charge voltage reached a first upper limit voltage of 11.7 V (the first step). Upon completion of the first step, the foregoing battery pack was subjected to a constant current charging at a second current of 0.3 It, which was smaller than the first current, until the charge voltage reached a second upper limit voltage of 12.6 V (the second step). Upon completion of the second step, the foregoing battery pack was subjected to a constant voltage charging at the foregoing second upper limit voltage until the charge current reduced to 100 mA (50 mA per one battery) (the third step).

Upon completion of the above charging, the battery pack was allowed to stand for 20 minutes. Thereafter, the battery pack was discharged at 1.0 It. The end-of-discharge voltage was set at 7.5 V (2.5 V per one battery).

The above charge/discharge cycle was repeated for a total of 300 cycles to evaluate the cycle life characteristics.

### Example 8

The first current was corrected every cycle on the basis of the deterioration ratio (0.2%) of the battery, by utilizing the cycle count function of the BMU incorporated in the battery pack. The deterioration ratio of the battery was determined from the data of the cycle life characteristics obtained in Example 7. Specifically, the first current value at the (n) th cycle was a value calculated by multiplying the first current value at the preceding (n−1)th cycle by 0.998. The charging and discharging were repeated in the same manner as in Example 7 except the above, to evaluate the cycle life characteristics.

### Example 9

The first current was decreased by 180 mA (90 mA per one battery) every 50 cycles by utilizing the cycle count function of the BMU, on the basis of the data of the cycle life characteristics of the battery obtained in advance (i.e., the data of the cycle life characteristics obtained in Example 7). The charge/discharge cycle was repeated in the same manner as in Example 7 except the above, to evaluate the cycle life characteristics.

The above test results are shown in Table 5.

TABLE 5

| | Initial | Charging | Capacity |
|---|---|---|---|
| | charging | time after | retention |
| | time | 300 cycles | rate |
| | (min) | (min) | (%) |
| Example 7 | 183 | 202 | 76 |
| Example 8 | 183 | 191 | 80 |
| Example 9 | 183 | 192 | 80 |

In Example 7 in which the charging was performed without changing (correcting) the first current during the charge/discharge cycles, the charging time after 300 cycles was about 20 minutes longer than the initial charging time. In contrast, in Examples 8 and 9 in which the first current was corrected during the charge/discharge cycles, the charging time after 300 cycles was merely about 10 minutes longer than the initial charging time. Compared to Example 7 in which the first current was not corrected, the increase of charging time associated with the charge/discharge cycles was suppressed. Further, in the battery pack subjected to repeated charging and discharging under the conditions of Example 8 and 9, compared to the battery pack subjected to repeated charging and discharging under the conditions of Example 7, the capacity retention rates were high, and the cycle life characteristics were further improved by correcting the first current.

As is evident from the foregoing results, when charging and discharging are repeated by employing the charging method of the present invention, it is possible to achieve both a shortened charging time and an improvement in cycle life characteristics. Further, by correcting the first current in the charging, depending on the charge/discharge cycles, the increase of charging time associated with the charge/discharge cycles is suppressed, and the cycle life characteristics are improved.

### INDUSTRIAL APPLICABILITY

The lithium ion secondary battery employing the charging method and the charging/discharging method of the present invention is suitably used as a power source of an electronic device such as a cellular phone and an information device.

1. A charging method of a lithium ion secondary battery including, as a positive electrode active material, a lithium-containing composite oxide containing nickel and cobalt and having a layered crystal structure, the method comprising:
a first step of charging said battery at a first current of 0.5 to 0.7 It until the charge voltage of said battery reaches a first upper limit voltage of 3.8 to 4.0 V;
a second step of charging said battery, upon completion of said first step, at a second current smaller than said first current until the charge voltage of said battery reaches a second upper limit voltage greater than said first upper limit voltage; and
a third step of charging said battery, upon completion of said second step, at said second upper limit voltage.

2. The charging method of a lithium ion secondary battery in accordance with claim 1, said lithium-containing composite oxide is represented by the general formula: LiNiₓCo_{y}M_{(1-x-y)}O₂, where M is at least one element selected from the group consisting of Group 2 elements, Group 3 elements, Group 4 elements, and Group 13 elements in the long form of the periodic table, and x and y satisfy 0.3≦x<1.0 and 0<y<0.4.

3. The charging method of a lithium ion secondary battery in accordance with claim 1, wherein said second upper limit voltage is 4.0 to 4.2 V.

4. The charging method of a lithium ion secondary battery in accordance with claim 1, wherein said second current is 0.3 to 0.5 It.

5. A charging/discharging method of a lithium ion secondary battery comprising a step of repeating a cycle of charging said battery according to the method of claim 1 and subsequent discharging, wherein said first current is decreased at a predetermined rate every cycle.

6. A charging/discharging method of a lithium ion secondary battery comprising a step of repeating a cycle of charging said battery according to the method of claim 1 and subsequent discharging, wherein said first current is decreased by a predetermined value at intervals of a predetermined number of cycles.
